(19) United States
(12) Patent Application Publication
(10) Pub. No.: US 2014/0258029 A1
(43) Pub. Date: Sep. 11, 2014

(54) EMBEDDED MULTIMEDIA INTERACTION PLATFORM

(71) Applicant: NABZEM LLC, Los Angeles, CA (US)

(72) Inventors: Fabien Thierry, Calabasas, CA (US); Michael Giles, Huntington Beach, CA (US)

(73) Assignee: Nabzem LLC, Los Angeles, CA (US)

(21) Appl. No.: 13/789,584

(22) Filed: Mar. 7, 2013

(51) Int. Cl. G06Q 30/06

(52) U.S. Cl. CPC G06Q 30/0643
USPC 705/26.8; 705/27.2

(57) ABSTRACT

A video commerce application having a graphical user interface (“GUI”) is described. The GUI includes: a single frame video display area for presenting video content; a floating menu box located within the single frame video display area for providing a consumer with multiple interactive control elements comprising: at least one media navigation tool; a product catalogue tool; an account access tool; and a shopping cart for storing product items selected for purchase by the consumer, wherein selection of a shopping cart tool associated with the shopping cart provides the consumer with a second pop out display within the single frame video display area for completing a transaction to purchase items present in the shopping cart, wherein the transaction does not require the consumer to register for an account with a commerce platform.

### BACKGROUND

Web-based multimedia content is ubiquitous. Manufacturers, service providers, and others may wish to offer products, services, and/or other interactive features to viewers of the content. Thus there is a need for a way to embed ecommerce features into multimedia content that can be played using widely available media players.

### BRIEF SUMMARY

Some embodiments may provide ways to provide multimedia content (e.g., video content, still pictures or graphics, etc.) with embedded advertising and ecommerce features. Such multimedia content may be provided using various appropriate pathways and/or interfaces (e.g., the Internet, one or more wireless networks, one or more cellular networks, etc.). Various user interfaces (UIs), services, and/or content may be provided such that users may be able to generate content with embedded features. The embedded features may be associated with the content in various appropriate ways (e.g., an embedded feature may be associated with a time trigger, associated with an element displayed in the content, etc.).

Such content with embedded features may be made available to consumers in various appropriate ways. For instance, the content (or a multimedia player associated with the content) may be included on a web site (e.g., a social networking site, a merchant web site, etc.), may be made available via a mobile device application, etc.

If a user accesses the content with embedded features, some embodiments may provide a menu box that provide various playback control options (e.g., play, pause, volume, etc.) and/or provides for the display of various offered items (e.g., products, services, etc.) and interactive review and/or action (e.g., purchase, submission, etc.) by the user.

Some embodiments provide content that is appropriate for broadcast (e.g., via a cable television provider) and/or is appropriate to be provided over one or more content delivery networks (CDNs), as appropriate.

Such content may include various motion control features. Such features may be implemented using body position sensing elements, motion sensing devices (e.g., game controllers, remote controls, etc.), touch screen devices, and/or other appropriate devices and/or systems. Such motion control features may include, for instance, pausing and/or playing a video, scrolling through products associated with the video content, perform an action (e.g., purchase, submission, etc.), etc.

The content of some embodiments may include elements (e.g., a visual feature of the multimedia content) that may be identified in various appropriate ways (e.g., by “tagging” the product, by selecting an outline of the product, by associating an avatar or other virtual element with the product, etc.). Such elements may be recognized during playback of the media, and be able to be tracked in some embodiments. Thus, for instance, advertising data associated with a product (e.g., a handbag) may be associated with one or more depictions of the product that appear during a video (e.g., when a wearer of the handbag appears, when a wearer of a handbag with an alternative color or material appears, etc.). Such advertising or marketing data may change in accordance with the appearance of the product within the content.

One exemplary embodiment provides a non-transitory computer readable medium storing a video commerce application that when executed by at least one processor provides a video player having a graphical user interface (“GUI”). The GUI includes: a single frame video display area for presenting video content; a floating menu box, where the floating menu box is located within the single frame video display area for providing a consumer with multiple interactive control elements, the interactive control elements include: at least one media navigation tool for controlling the viewing of video content provided in the single frame video display area; a product catalogue tool, where interaction with the product catalogue tool provides the consumer with a first pop out display within the single frame video display area and on top of the video content for presenting one or more products presented in the video presentation for purchase; an account access tool for managing consumer account information; and a shopping cart for storing product items selected for purchase by the consumer, where selection of a shopping cart tool associated with the shopping cart provides the consumer with a second pop out display within the single frame video display area for completing a transaction to purchase items present in the shopping cart, where the transaction does not require the consumer to register for an account with a commerce platform of the video commerce application, where viewing the video content in the single frame video display area provides the consumer with selectable product items displayed during the presentation of the video content without interrupting the viewing of the video content and allowing the purchase of those items without requiring the consumer to depart away from the single frame video display area.

Another exemplary embodiment provides a method for providing a video commerce presentation that allows a consumer to purchase items within the video commerce presentation. The method includes: providing a video commerce player, where the video commerce player includes: a single frame video display area for presenting video content; and a floating menu box, where the floating menu box is located within the single frame video display area for providing a consumer with multiple interactive control elements; providing an online product management program for a vendor to define products for sale; providing remote storage for storing vendor produced video content; receiving a vendor video for hosting; receiving the identification of one or more vendor products defined in the online product management program; associating the identified vendor products with the vendor video; displaying the video commerce player on a vendor defined web page; streaming the vendor video from the remote storage for display in the single frame video display area of the video commerce player; and retrieving the product information for the identified vendor products from the online product management program for display within the single frame video display area.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual system of some embodiments;

FIG. 2 illustrates a flow chart of a conceptual process of some embodiments;

FIG. 3 illustrates a schematic block diagram of a conceptual system provided by some embodiments;

FIG. 4 illustrates a schematic block diagram of a conceptual software system provided by some embodiments;

FIG. 5 illustrates a conceptual data structure diagram representing multimedia content with embedded features provided by some embodiments;

FIGS. 6-8 illustrate various UI features and elements provided in a multimedia player of some embodiments;

FIG. 9 illustrates a multi-region UI of some embodiments;

FIGS. 10A-10D illustrate various conceptual video frames that provide an example of object identification and tracking provided by some embodiments;

FIGS. 11-17 conceptually illustrate various motion control features that may be provided by some embodiments;

FIG. 18 illustrates a flow chart of a process used by some embodiments to generate content;

FIG. 19 illustrates a flow chart of a process used by some embodiments to allow content access;

FIG. 20 illustrates a flow chart of a client process used by some embodiments to interact with a consumer;

FIG. 21 illustrates a flow chart of a server process used by some embodiments to interact with a consumer;

FIG. 22 illustrates a flow chart of a client process used by some embodiments to allow a consumer to make a purchase or submit information;

FIG. 23 illustrates a flow chart of a server process used by some embodiments to allow a consumer to make a purchase or submit information;

FIG. 24 illustrates a flow chart of a conceptual process used by some embodiments to identify and track an object displayed in some multimedia content;

FIG. 25 illustrates a flow chart of a process used by some embodiments to implement motion control; and

FIG. 26 conceptually illustrates a schematic block diagram of a computer system with which some embodiments of the invention may be implemented.

### DETAILED DESCRIPTION

Numerous details, examples, and embodiments of the invention are set forth and described below. However, it will be clear and apparent to one skilled in the art that the invention is not limited to the embodiments set forth herein and that the invention may be practiced without some specific details discussed below.

Several more detailed embodiments of the invention are described in the sections below. Section I provides an overview of some embodiments. Section II then provides a conceptual description of the operating platform provided by some embodiments. Next, Section III describes various exemplary implementation elements that may be provided by some embodiments. Section IV then describes various methods of operation used by some embodiments. Lastly, Section V describes a computer system which implements some of the embodiments of the invention.

### I. OVERVIEW

Although various details are set forth below, one of ordinary skill in the art will recognize that the following overview is intended to provide a brief description of some features provided by some embodiments. The overview is not meant to limit the other sections of the Detailed Description and various alternatives to the features described in reference to Section I may be provided.

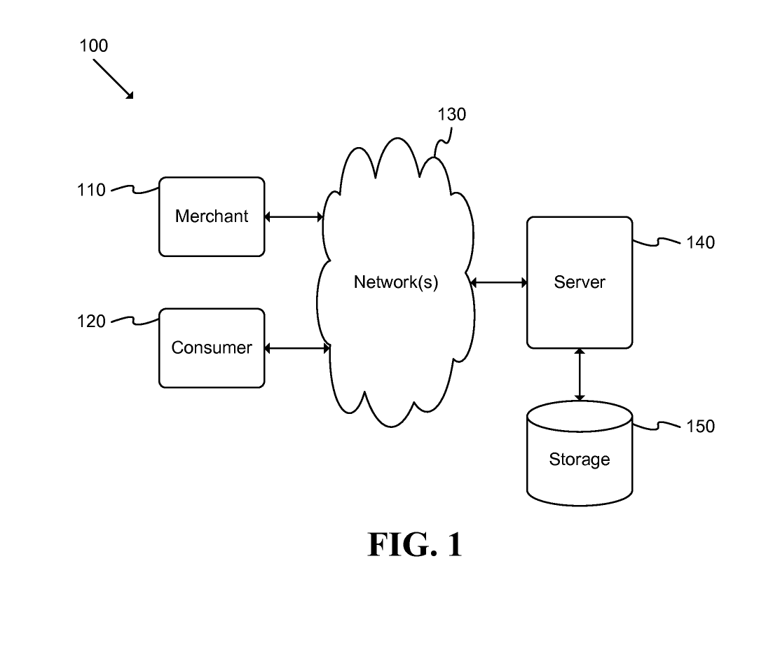

FIG. 1 illustrates a schematic block diagram of a conceptual system 100 of some embodiments. As shown, the system includes a merchant 110, a consumer 120, one or more networks 130, a server 140, and a storage 150. The merchant 110 and/or consumer 120 may access the network 130 using various appropriate devices (e.g., PCs, smartphones, tablet devices, etc.). The network 130 may include various devices, interfaces, and/or protocols, as appropriate. The server 140 may be a device capable of executing instructions and/or processing data. The storage 150 may include elements adapted to store data and/or instructions.

One of ordinary skill in the art will recognize that system 100 is conceptual in nature and may be implemented in various different ways without departing from the spirit of the invention. For instance, different embodiments may include various other elements (e.g., 3^{rd}-party server(s), local storage(s), etc.). As another example, some functions of the system may be provided without use of a server (e.g., an application programming interface or “API” may access one or more storages (and/or other external resources) directly across a network, without need for a server). As yet another example, although some components are represented as single elements (e.g., the merchant, consumer, server, storage), some embodiments may allow multiple instances of each element, as appropriate (e.g., multiple merchants and/or consumers may be associated with the system, and/or multiple servers and/or storages may be included in the system).

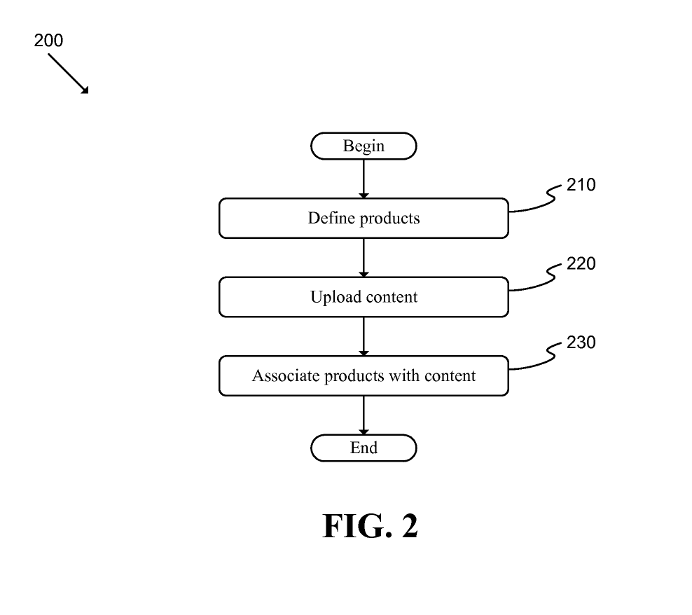

FIG. 2 illustrates a flow chart of a conceptual process 200 of some embodiments. Such a process may begin when a merchant (e.g., merchant 110) accesses a system of some embodiments (e.g., system 100). Some embodiments may provide various UIs that may allow the merchant to interact with the system. Such UIs may include various pop-up and/or pull-down menus, tabs, links, etc., that may allow a merchant to provide information, select options, and/or otherwise interact with the system.

Next, the process may allow the merchant to define (at 210) one or more products (and/or services, promotions, etc.). Some embodiments may provide, for instance, an online form that allows a merchant to input data associated with each product (e.g., description, price, picture, etc.). Such product definitions may be received by a server (e.g., server 140) and stored appropriately (e.g., at storage 150).

The process may then allow the merchant to upload (at 220) content. Such content may include, for example, video content, audio content, multimedia content, graphical content, etc. Various appropriate UIs may be provided to upload the content, and the content may be received by a server (e.g., server 140) and stored appropriately (e.g., at storage 150).

Next, the process may allow a merchant to associate (at 230) the defined products with the content. Such association may include various references to the product (e.g., a link to a product entry) and/or content (e.g., a time reference for the product, a location associated with the product, etc.). In some embodiments, the references to associated products may be embedded within the content.

The content may then be made available to various consumers in various appropriate ways. For instance, some embodiments may provide a system that allows consumers to access the content (e.g., an ecommerce site). As another example, some embodiments may allow a merchant to upload the content (and embedded product associations) to an external or 3^{rd}-party website that is accessible to consumers. In any case, when a consumer then accesses the content (e.g., using a multimedia player), various interactive elements related to each embedded product association may be provided to the consumer through the media player (including ecommerce options, product information, etc.).

One of ordinary skill in the art will recognize that process 200 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

### II. PLATFORM

Sub-section II.A provides a conceptual description of the system architecture of some embodiments. Sub-section II.B then describes a conceptual software architecture used by some embodiments. Lastly, sub-section II.C describes conceptual data structures utilized by some embodiments.

A. System Architecture

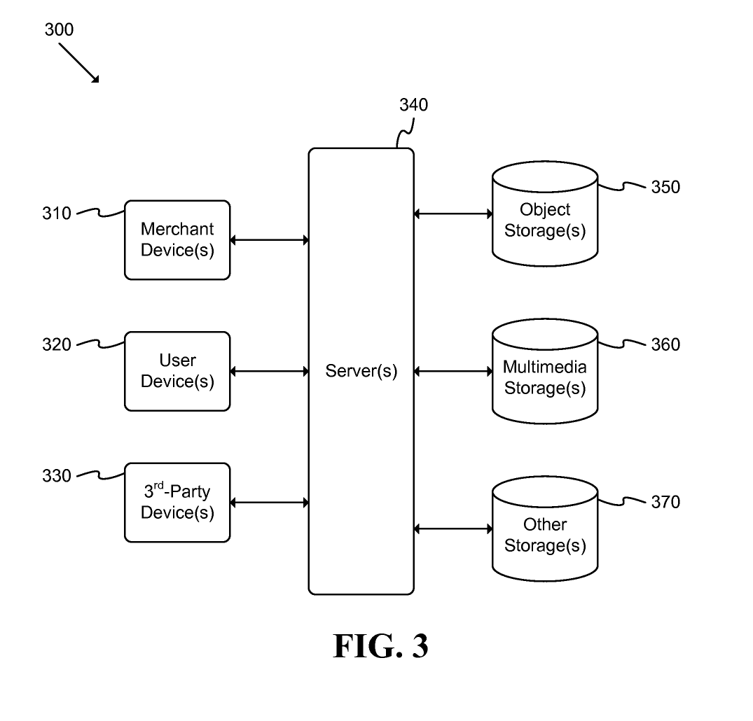

FIG. 3 illustrates a schematic block diagram of a conceptual system 300 provided by some embodiments. Specifically, this figure shows several system elements and the communication pathways among the elements. As shown, the system may include one or more merchant devices 310, one or more user devices 320, one or more 3^{rd}-party devices, one or more servers 340, and one or more storages 350-370.

Each device 310-330 may be any device capable of connecting to one or more networks and allowing a user to interact with various elements (e.g., a mobile device such as a smartphone, a personal computer or PC, a tablet device, a television (TV), etc.). In this example, a merchant device 310 may be a device associated with a producer, service provider, etc. Similarly, a user device 320 may be associated with a consumer and the 3^{rd}-party device may be associated with a third party (e.g., a system administrator, a marketing firm, etc.).

The server(s) 340 may include one or more computing devices that are able to process data and/or instructions. Such servers may be able to communicate among the various devices 310-330 (e.g., over the Internet). In addition, the servers 340 may be able to access the various storages 350-370 (e.g., over a local network, over the Internet, etc.). In some embodiments, various server functionalities may be provided by external devices, systems, networks, etc. (e.g., some embodiments may interact with one or more 3^{rd}-party servers, web portals, etc.).

Each of the storages 350-370 may be adapted to store data and/or instructions and be able to pass such data and/or instructions to at least one server 340 or other appropriate device. In this example, the object storage 350 may include data associated with various products or services, the multimedia storage 360 may be associated with multimedia content, and the other storage 370 may include other data (e.g., user account information, merchant information, etc.). In some embodiments, the multimedia storage 360 may include a server and/or other elements appropriate for hosting video content.

In some embodiments, the elements of system 300 may allow a user to create and/or manage product data, multimedia content, v-commerce presentations, etc. In addition, the system may provide hosting (e.g., of media content, product data, etc.) and/or other appropriate services without requiring use of any 3^{rd}-party resources. In this way, the system is able to provide a complete consumer solution that may allow users to generate v-commerce presentations to sell their own goods or services.

During operation, a merchant device 310 may access the server 340 to generate multimedia content. Such content may be stored in the multimedia storage 360 and may refer to various products or services stored in the object storage 350. Various users may then access the server 340 using one or more user devices 320. The server 340 may retrieve multimedia content from the multimedia storage 360 and provide the content to the user device 320. The user device may then interact with the server 340 to receive information related to various objects from the object storage 350 and/or to purchase, submit, and/or otherwise interact with the content and/or content provider.

One of ordinary skill in the art will recognize that the example system 300 may be implemented in various different ways without departing from the spirit of the invention. For instance, the storages may be distributed across multiple elements and/or devices or may all be included in a single element or device. As another example, the server element may be implemented using multiple devices or elements acting as a single unit.

B. Software Architecture

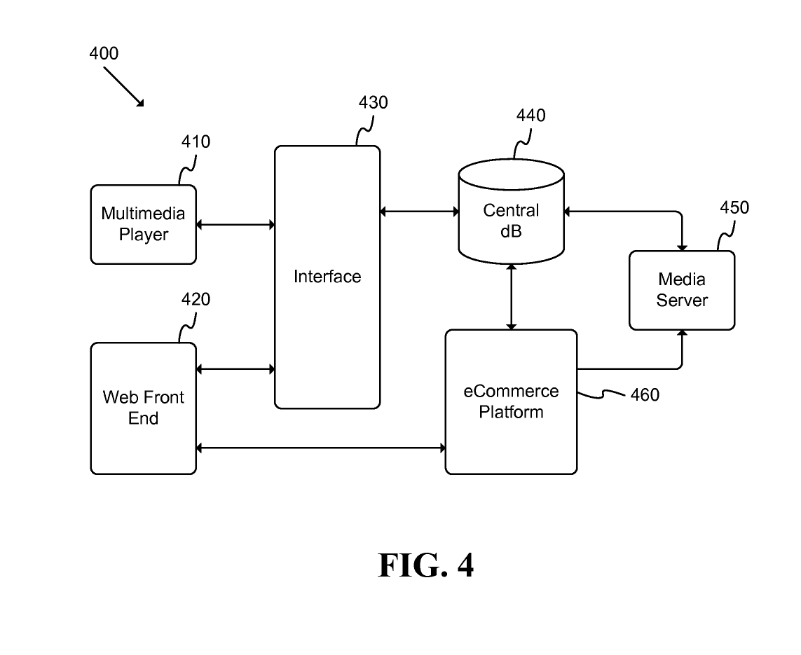

FIG. 4 illustrates a schematic block diagram of a conceptual software system 400 provided by some embodiments. Specifically, this figure shows various elements that may allow the elements of system 300 to interact. As shown, the system 400 includes a multimedia player 410, a web front end 420, an interface 430, a central database 440, a media server 450, and an ecommerce platform 460.

The multimedia player 410 may be adapted to play various multimedia files, including multimedia files having embedded content. For example, some embodiments may include a Flash multimedia player. The multimedia player may be provided using resources of a user device (e.g., user device 320). The multimedia player may play multimedia files with embedded content. Such content may be embedded in various appropriate ways, as described below. The multimedia player may be able to access one or more networks, interfaces, etc. For instance, a multimedia player may be embedded in a web page and allow a user to control operations associated with the player. As another example, the multimedia player may be able to send and/or receive data and/or instructions across an interface (e.g., an API). In some embodiments, the multimedia player 410 dimensions (e.g., width and height) may be able to be defined by a user based on the content, products, and/or other appropriate factors.

The web front end 420 may allow various users (e.g., merchants, consumers, etc.) to communicate with other elements of the system and/or to process data and/or instructions. In some embodiments, the web front end may provide a virtual storefront that allows a seller to provide various multimedia content items, each of which may refer to one or more products and/or services stored in a database (e.g., database 440). Such a storefront may be accessible to various consumers (e.g., through a web site) using the web front end 420 in some embodiments. The web front end may be accessed using various devices (e.g., devices 310-330).

The interface 430 may include one or more APIs (and/or other appropriate elements) that may allow multimedia players 410 and/or web-based elements 420 to communicate among the other elements 440-460. In some embodiments, the interface 430 may allow instructions and/or data to be passed among the various elements of the system 400. The interface 430 may be accessible via a web server (e.g., server 340).

The central dB 440 may store data and/or instructions used by the system. For instance, the central dB 440 may include data and/or instructions related to the storages 350-370 described above in reference to system 300. The media server 450 may store media content accessed by system 400.

The ecommerce platform 460 may be adapted to provide various commerce features. The platform may include various UIs, data, instructions, etc. that may allow merchants to create storefronts, marketing and advertising content, etc. In addition, the platform may allow consumers to review products, make purchases, etc.

During operation, content providers may access the system through the web front end 420. The providers may be able to generate media content with embedded features and associate various features with products, services, etc. utilizing the interface 430, central dB 440, media server 450, and ecommerce platform 460. Various consumers may access the system 400 by invoking a multimedia player 410 (e.g., by clicking a web link, accessing a web site, etc.). When playing media content with embedded features, the media player 410 may automatically execute various instructions such that one or more messages, commands, data, etc. are sent to and/or received from the interface 430. The multimedia player 410 may be able to access the central dB 440, and thus the media server 450 and ecommerce platform 460, through the interface 430.

In general, content providers may provide content through a web site (e.g., a site associated with web front end 420), by sharing the content in a social media environment, and/or by embedding content in a merchant (or third-party) website.

One of ordinary skill in the art will recognize that the system 400 may be implemented in various different ways without departing from the spirit of the invention. For instance, some embodiments may include 3^{rd}-party applications that are able to access the interface 430. As another example, some embodiments may include links to external resources (e.g., servers, storages, etc.), which may include one or more network connections.

C. Data Structures

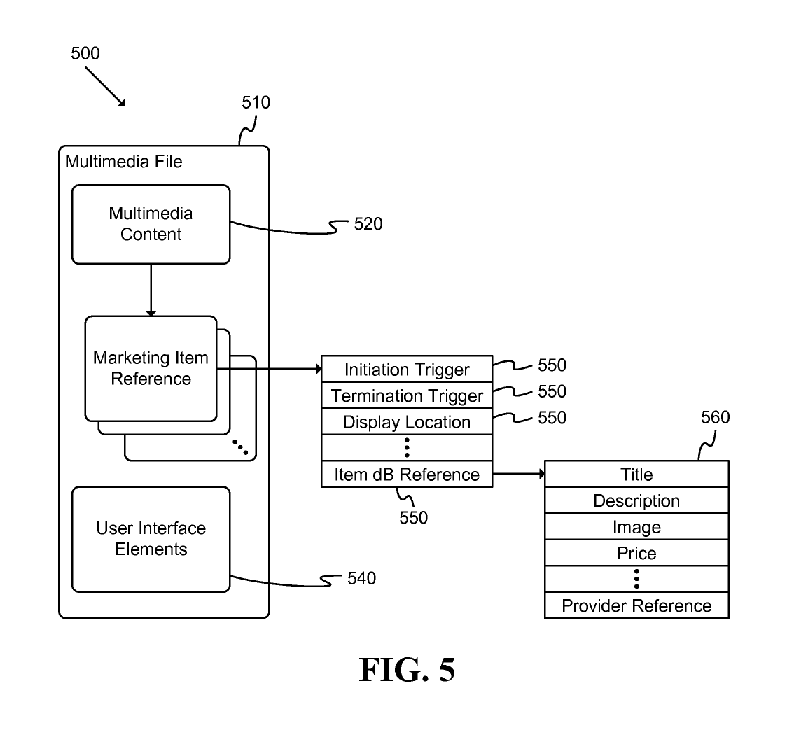

FIG. 5 illustrates a conceptual data structure diagram 500 representing multimedia content with embedded features provided by some embodiments. Specifically, this figure shows various data elements that may be used by some embodiments.

As shown, the structure 500 may include a multimedia file having associated multimedia content 520, one or more marketing item references 530, and/or various UI elements 540. Each marketing item reference 530 may include various sub-elements 550, where a set of sub-elements may refer to product structure 560 (and/or other elements, marketing references, UI elements, structures, etc.).

In the example structure 500, the various sub-elements 550 are related to various UI(s) and criteria for initiating a consumer interaction (as well as a reference to a dB item). The item dB references 560 may include various sub-elements related to products and/or services to be provided for consumer interaction. In some embodiments, a merchant or other provider of content with embedded features may use system 400 to generate a multimedia file 510 with various embedded features 530-540. In addition, a merchant may be able to define various items, products, or services as defined by structure 560 (e.g., using web front end 420).

In some embodiments, the various marketing item references 530 may be generated by accessing an admin section of some embodiments, tagging an item in a video, by scrolling back and forth within a video tool provided in the admin section and selecting when the product should be displayed.

One of ordinary skill in the art will recognize that the structures used by some embodiments may differ from those described in reference to FIG. 5 without departing from the spirit of the invention. For instance, marketing item references 530 may include various different and/or additional elements 550 than those shown.

### III. EXEMPLARY IMPLEMENTATION ELEMENTS

Sub-section III.A provides a conceptual description of a menu box provided by some embodiments. Sub-section III.B then describes a multi-region display used by some embodiments. Next, sub-section III.C describes object identification and tracking of some embodiments. Lastly, sub-section III.D describes various motion control features provided by some embodiments.

A. Menu Box

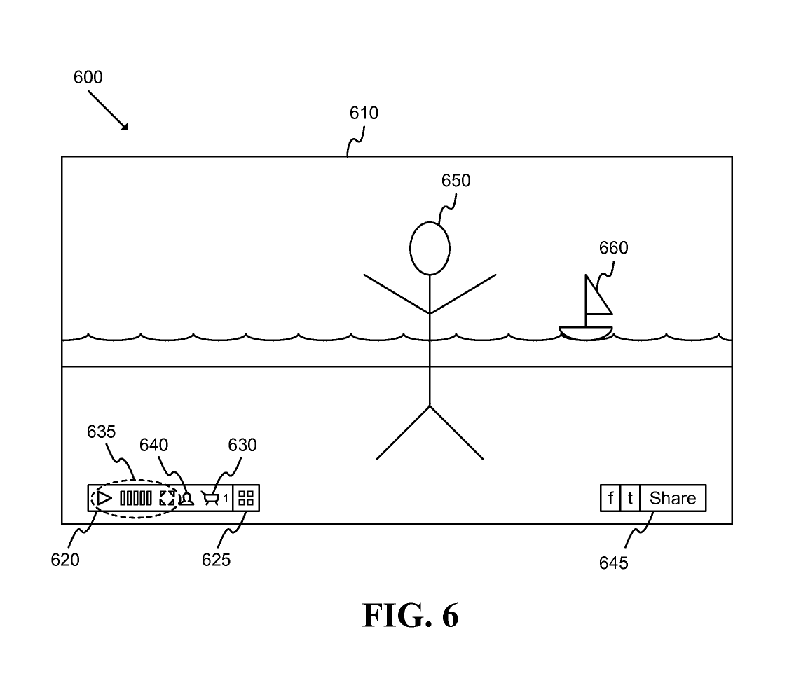

FIGS. 6-8 illustrate various UI features and elements provided in a multimedia player of some embodiments. One of ordinary skill in the art will recognize that the features shown are for example purposes only and that different embodiments may differ in various ways. For instance, different embodiments may have differently-sized elements, differently-shaped elements, different UI components, different numbers of elements, etc.

FIG. 6 illustrates an example multimedia player 600 that may be provided by some embodiments. As shown, the multimedia player 600 may include a single frame video display area 610, a menu box/tool bar 620 that may include several consumer interaction elements 625-640 (or “interactive control elements”, or “tools”), various reference elements 645 associated with 3^{rd}-party sites and/or other resources, and/or other appropriate UI elements. In addition, the example video frame shown in the display area 610 includes a model 650 and an object 660.

In some embodiments, various consumer interaction elements 625-640 may be included in the menu box 620. Such elements may include a product catalogue tool 625, a shopping cart tool 630, media navigation tools 635 for controlling the viewing of content in the display area 610 (e.g., play, pause, volume, navigation, screen size interactive elements, etc.), and/or a user account access tool 640, as appropriate. The menu box 620 may appear as a floating toolbar that is integrated into the multimedia player 600 within the display area 610 so all interactions within the multimedia player 600 may occur in a single frame in order to allow a user to perform various actions within a seamless and user friendly environment.

For instance, a user may press the product catalogue tool 625 in the toolbar 620 before playback of a video commences (or after playback is finished) to display all items for sale associated with the video (e.g., by displaying a set of thumbnail images). As another example, a user may set the element to display a pop-up of an item when on screen or to show another indication (e.g., “glowing”, changing color, shape, size, etc.) that a visible item is included in the set of items for sale associated with the video content.

The shopping cart 630 may allow one or more selected product items to be stored for purchase. In some embodiments, selection of the shopping cart tool 630 causes a pop out display to appear. Such a display may allow a consumer to complete a purchase transaction for any items stored in the shopping cart. Some embodiments allow a consumer to make a purchase without requiring the consumer to have an account associated with the ecommerce platform of some embodiments. In some embodiments, a fillable transaction form (not shown) may protrude from the shopping cart based on a user selection (e.g., when a user clicks the shopping cart tool, when a user adds an item to the shopping cart, etc.). The fillable transaction form may allow a consumer to set quantities of each item for purchase, remove items from the shopping cart, modify items in the shopping cart (e.g., by selecting a different size, color, etc.), etc.

The user account access tool 640 may allow a consumer to manage account information (e.g., contact information, username, password, etc.). In some embodiments, the user account access tool may be displayed as unavailable for interaction when the consumer is not registered with the ecommerce platform of some embodiments. Such unavailability may be indicated by, for example, shading the tool differently than other interactive control elements.

A UI may be presented in accordance with various still picture (and/or other graphic) content within the multimedia player 600 so that no other frames are required to display secondary content. For instance, a still picture may include one or more items that have been tagged and/or otherwise associated with merchant products/services/etc. for sale within the multimedia presentation displayed in the multimedia player 600. A user may then be able to select the various tagged items to review information, add items to a shopping cart 630, etc.

In some embodiments, a media player may receive user inputs and securely transmit transactional data via an interface (e.g., interface 430) to an ecommerce platform. The ecommerce platform may connect directly via a web service API, for instance, to the merchant server and then transmit transactional data (e.g., product, price, address, billing information, etc.). The merchant server may process the information and return values that indicate whether the transaction(s) were successful or declined. The returned information may be communicated through an interface (e.g., interface 430) and back to the media player, which may display the results of the returned data.

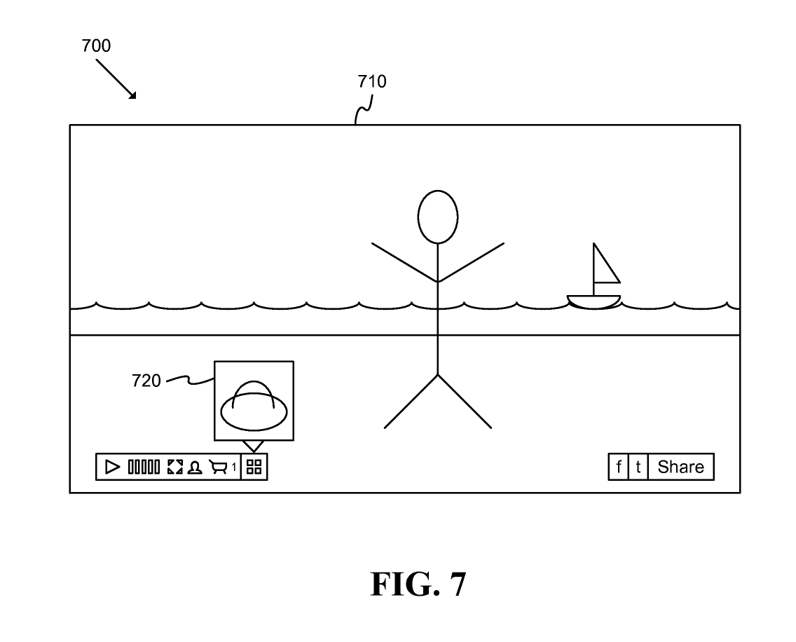

FIG. 7 illustrates another example multimedia player 700 that may be provided by some embodiments. A main display area 710 may include, in addition to or in place of the various elements of display area 610, an item display window 720. Such a display window may be invoked when a defined product is associated with content being displayed. For instance, in the example of multimedia player 700, a product in the display window 720 may be associated with the model 650 (e.g., the product may be the same brand or object as some item worn or used by the model, may be associated with a location shown in the video frame, etc.). Alternatively, the product in the display window 720 may be associated with the object 660 in the example video frame (e.g., the display window 720 may be invoked whenever the object 660 is visible in the frame). In some embodiments, a user may be able to invoke the display window 720 (e.g., by “clicking” within a consumer interaction element 625-640, by pressing a combination of keys, etc.).

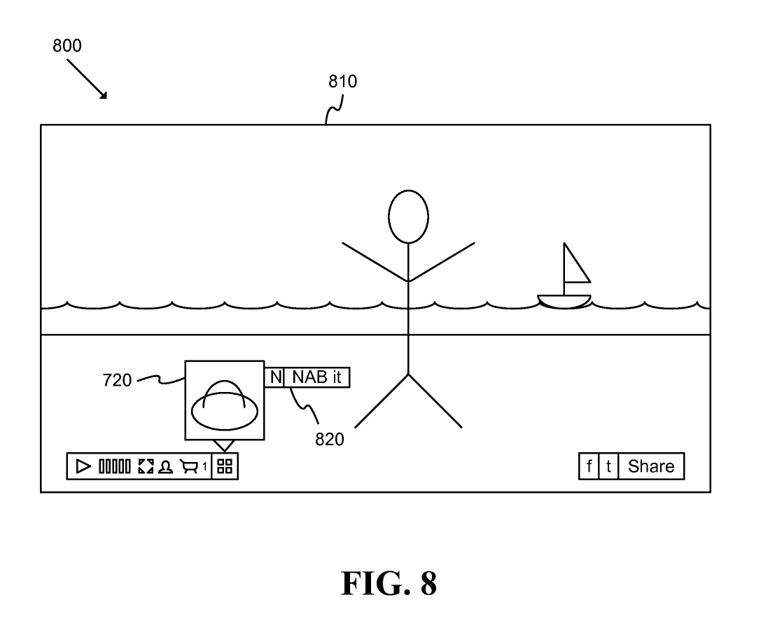

FIG. 8 illustrates yet another example multimedia player 800 that may be provided by some embodiments. A main display area 810 may include, in addition to or in place of the various elements of display area 610 and/or display area 710, an action element 820. Such an action element may be invoked in various different ways (e.g., based on items associated with the content, based on options provided by a merchant, based on a user action or selection, etc.).

In some embodiments, the action element 820 (and/or other elements) may allow a consumer to participate in an ecommerce interaction (e.g., by providing UI elements that allow a user to purchase a product from a seller, processing of payments (e.g., credit card transactions), etc.). For example, the action element 820 may present itself when an item for purchase is present in the multimedia player 800. Clicking on the action element 820 may place the particular item identified into a shopping cart for viewing of items after the multimedia presentation is viewed in its entirety or anytime in between when the user interacts with the shopping cart element 630.

In some embodiments, if a user selects a product (e.g., by clicking within the display window 720), a product description overlay may be invoked (not shown). Such a product description overlay may appear within the display area 810 and may protrude from the window 720 in a similar manner to the action element 820. The product description overlay may include information associated with the product (e.g., sizes, colors, materials, manufacturer, reviews, consumer ratings, etc.).

A consumer may be able to view product details of selected items via the shopping cart element or all product details associated with the multimedia content using the product catalogue tool 625. Once the consumer is ready to complete a transaction, he may enter billing details and checkout thereby purchasing items in a seamless integrated fashion from within a single frame of the multimedia player. Furthermore, there is no need for the user to register with a particular service to make a purchase within the platform of the present invention. This provides less friction for a transaction to take place therefore providing a higher likelihood of a sale to take place.

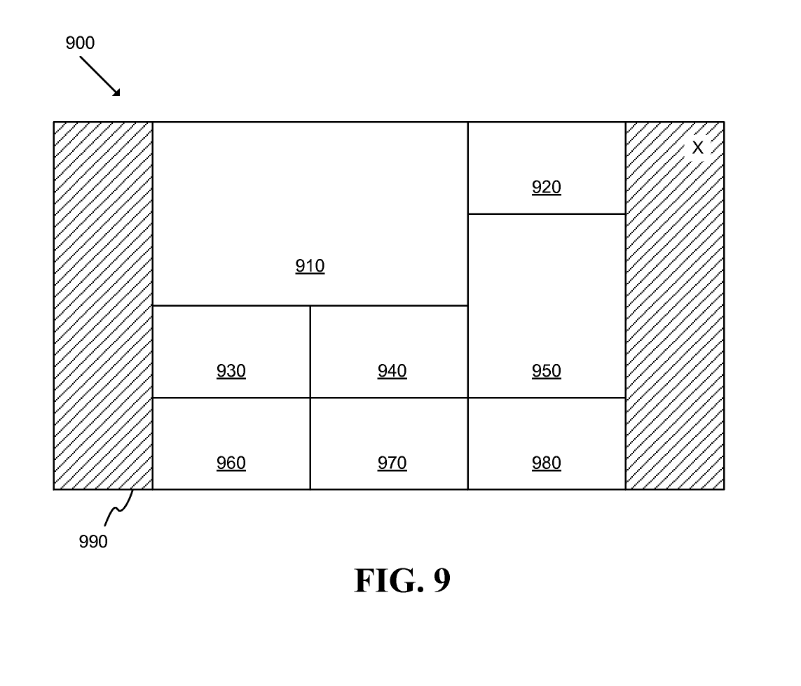

The use of a single frame allows the focus to remain on the multimedia content at all times and present the consumer with a user friendly and streamlined, natural view of the content so the consumer is not distracted with several frames that may be continuously present for displaying advertising or product for sale (although other embodiments may user multiple frames as discussed below in reference to FIG. 9). The clean and crisp presentation of the ecommerce platform within the single frame of the multimedia player 800 is a non-obtrusive method that allows for merchants to present a their products via multimedia content, and when combined with the ability to complete a transaction without registration with the content provider or merchant/seller increases the likelihood and conversion for actual sales when rich graphics and videos are presented seamlessly in connection with an ecommerce platform.

B. Multi-Region Advertising Display

FIG. 9 illustrates a multi-region UI 900 of some embodiments. As shown the display 900 may include various display regions 710-780 and/or one or more semi-transparent regions 790. Such a multi-region display 900 may include various elements in each display region 710-780 (e.g., one or more products, a name, logo, and/or other graphical display, product information, manufacturer information, etc.). The semi-transparent regions 790 may include semi-transparent colors and/or other graphics (the regions may also be completely transparent or opaque).

Such a display 900 may be invoked at various appropriate times in various appropriate ways. For instance, in some embodiments the display 900 may be invoked at the end of a video. Such a display may include each product that was marketed in the video and may allow a consumer to obtain more information about the products, purchase one or more products, contact the manufacturer, visit a website, etc.

C. Object Identification and Tracking

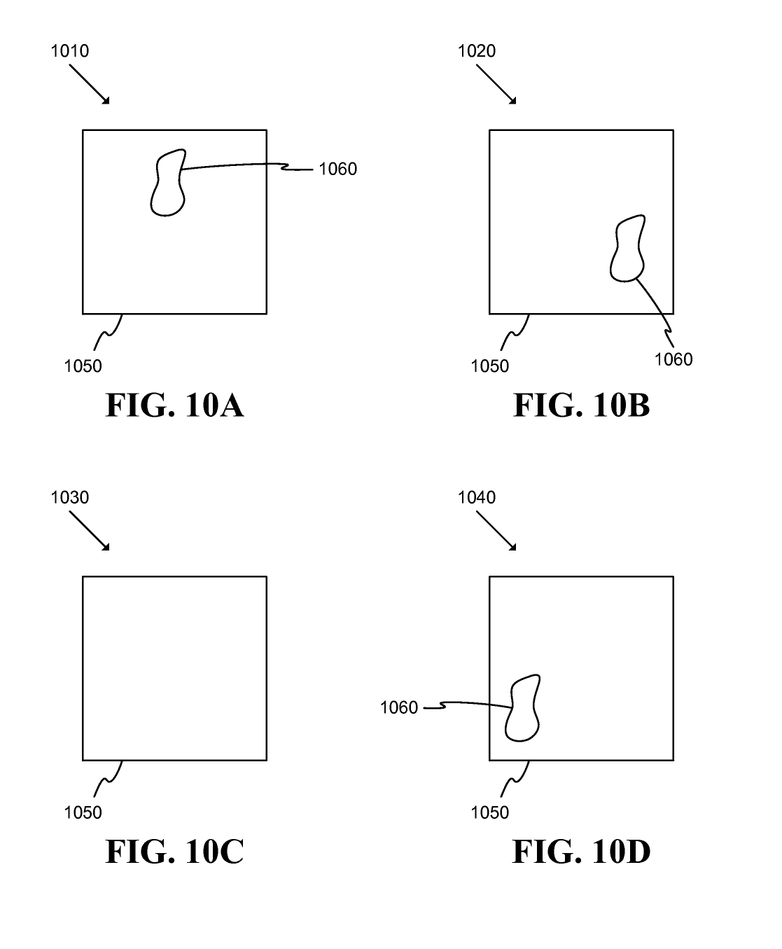

FIGS. 10A-10D illustrate various conceptual video frames 1010-1040 that provide an example of object identification and tracking provided by some embodiments.

FIG. 10A illustrates a first frame 1010 that may be displayed in a multimedia player window 1050 (or other appropriate element). In this example, an object 1060 has been identified. Such an identification may be performed in various appropriate ways. For instance, a merchant may define an object (e.g., by tracing around the edges of the object) when embedding information into some multimedia content. As another example, an object may be automatically identified (e.g., by a system that allows for edge recognition) and may then be associated with some product or item by a merchant. As still another example, an object may be defined in the media content (e.g., content may include computer-generated images, graphics, etc.), and the object may then be associated with an item. Although only one object has been identified in this example, one of ordinary skill in the art will recognize that multiple objects (or no objects) may be identified, as appropriate.

FIG. 10B illustrates a second frame 1020 displayed in window 1050. In this example, the object 1060 has moved to a different location within the frame 1020. Some embodiments may automatically track such movement in various appropriate ways. For instance, the area defined as the object 1060 in the first frame 1010 may be compared to various areas within the second frame 1020 and the object may be “tracked” when the various areas match various characteristics of the area defined as the object 1060 (e.g., matching size, colors, brightness, shape, etc.). Such comparisons may be performed in various appropriate ways.

FIG. 10C illustrates a third frame 1030 displayed in window 1050. In this example, the object 1060 does not appear in the frame 1030. In some embodiments, various UI features (and/or other appropriate features) may be invoked and/or removed depending on the appearance and/or placement of the object 1060. For instance, some embodiments may provide a menu box (e.g., menu box 620) when the object 1060 appears within a frame and remove the menu box when the object does not appear in a frame. As another example, different UI elements may be invoked when the object 1060 is displayed in different areas and/or under different conditions. Such UI elements may include components associated with the object 1060 in various different ways.

FIG. 10D illustrates a fourth frame 1040 displayed in window 1050. In this example, the object 1060 has returned to the area shown in the fourth frame 1040.

Although the frames 1010-1040 have been described as proceeding in a particular order, one of ordinary skill in the art will recognize that various objects may appear, move, disappear, change appearance or form, etc., in various different ways as multimedia content is played.

D. Motion Control

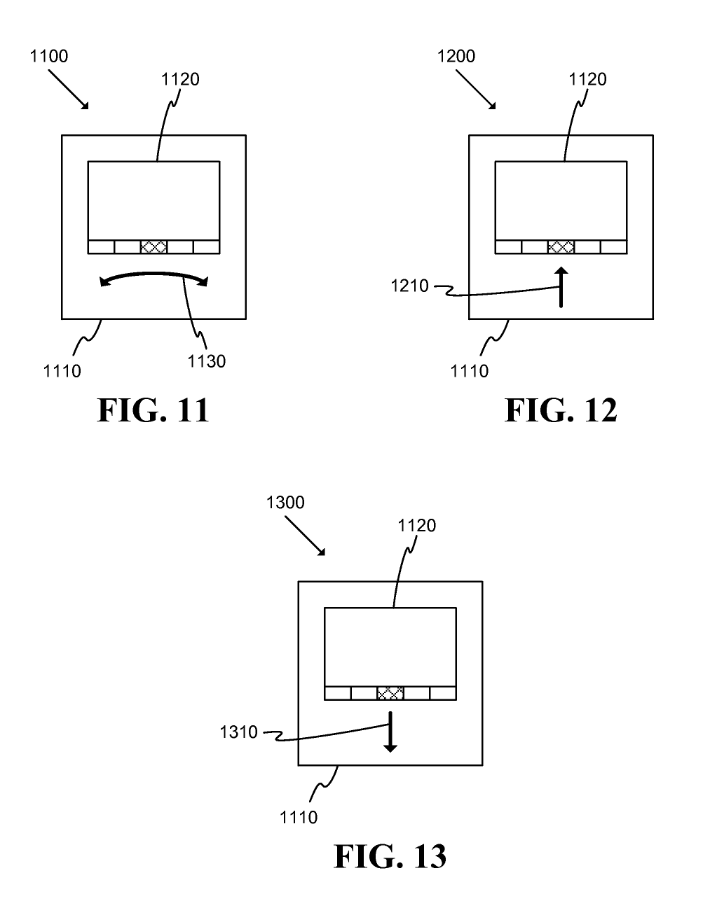

FIGS. 11-17 conceptually illustrate various motion control features that may be provided by some embodiments. Such motion control features may be implemented in various different ways using various different system components, movements, etc. Motion associated with the motion control features may be captured in various appropriate ways (e.g., using a system capable of determining the position of a user's hands, fingers and/or other features, capturing movement of a gaming controller or remote control, by capturing a user's movement along the surface of a touch screen, by capturing movement of a positioning device such as a mouse, etc.). The various control features described in reference to FIGS. 11-17 are provided as examples only and different embodiments may provide various different features which may be invoked with various different motions. Such motion control features may be provided in conjunction with content that is provided through a cable television service (and/or other appropriate content and/or providers).

FIG. 11 illustrates a motion control feature that may allow a consumer to cycle through a set of products associated with some content. As shown, a display 1100 may include a media player window 1110 (or other appropriate display, such as a television screen) that includes a product display feature 1120. The consumer may perform a left to right or right to left motion 1130 to cycle forward or backward through the set of products.

FIG. 12 illustrates a motion control feature that may allow a consumer to select a product. As shown, a display 1200 may include a media player window 1110 that includes a product display feature 1120. The consumer may perform an upward swiping motion 1210 (e.g., by moving her arms from a low to high position, by moving a remote control or gaming control in a generally straight upward direction, by swiping on a touchscreen device in a straight line from a low point to a high point along the screen, etc.) to select a displayed product.

FIG. 13 illustrates a motion control feature that may allow a consumer to remove (or delete, or “trash”, etc.) a product (e.g., from a shopping cart or other ecommerce feature). As shown, a display 1300 may include a media player window 1110 that includes a product display feature 1120. The consumer may perform a downward swiping motion 1130 to remove the displayed product.

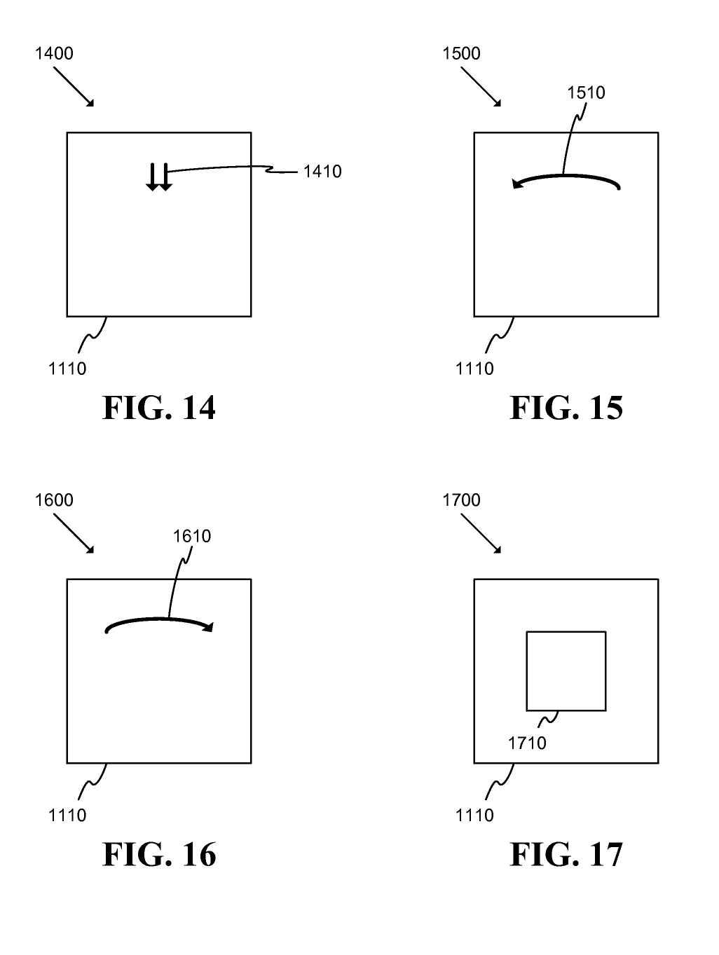

FIG. 14 illustrates a motion control feature that may allow a consumer to pause playback of a multimedia content item (e.g., a video). As shown, a display 1400 may include a media player window 1110. The consumer may perform a “double-tap” motion 1410 (e.g., by tapping with two fingers on a touchscreen device, by tapping with two fingers on a touchpad, etc.) to pause playback.

FIG. 15 illustrates a motion control feature that may allow a consumer to resume playback in some embodiments. As shown, a display 1500 may include a media player window 1110. The consumer may perform a right to left or left to right motion 1510 to resume playback of multimedia content.

FIG. 16 illustrates a motion control feature that may allow a consumer to proceed to a next product in a set of products. As shown, a display 1600 may include a media player window 1110. The consumer may perform a left to right motion 1610 to cycle forward to a next product in the set.

FIG. 17 illustrates a motion control feature that may allow a consumer to confirm a purchase. As shown, a display 1700 may include a media player window 1110. Alternatively, the window 1110 may be provided by another element (e.g., a remote control screen, a touchscreen, etc.). The consumer may press an identifying digit onto a receiving area 1710 to verify the user's identity before a purchase is authenticated. Alternatively, a user may swipe a fingerprint across a panel, satisfy a voice recognition algorithm, and/or otherwise verify the user's authority to make a purchase or perform some other action.

Although the various motion control features described above have included reference to certain particular features, one of ordinary skill in the art will recognize that the motion control features may be implemented in various different ways without departing from the spirit of the invention. For instance, although a particular motion (e.g., left to right movement) may have been described as being associated with a particular function (e.g., cycling to a next product), one of ordinary skill will recognize that various different identifiable motions (e.g., a right to left motion, a double-finger motion, etc.) may be associated with various different potential actions (e.g., selection of a product, acceptance of an offer, etc.).

### IV. METHODS OF OPERATION

Sub-section IV.A provides a conceptual description of a process used to generate content with embedded features. Sub-section IV.B then describes accessing content with embedded features. Next, sub-section IV.C describes various consumer interaction processes. Sub-section IV.D then describes various ecommerce processes. Next, sub-section IV.E describes a process used to identify and track objects. Lastly, sub-section IV.F describes various motion control features provided by some embodiments.

A. Content Generation

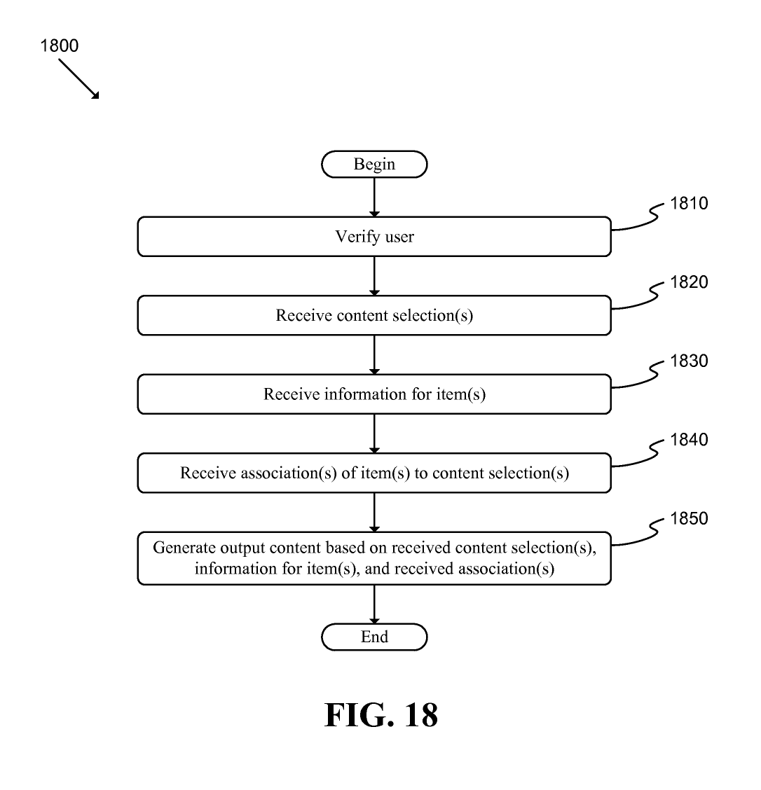

FIG. 18 illustrates a flow chart of a process 1800 used by some embodiments to generate content. Specifically, this figure shows a conceptual set of operations that may be used to generate content with embedded features used by some embodiments. The process may begin, for instance, when a user (e.g., a merchant) accesses a web-based front end provided by some embodiments (e.g., web front end 420).

Process 1800 may then verify (at 1810) the user. Such verification may include providing various prompts (e.g., a username and password) and receiving a set of responses (e.g., the username and password). Next, the process may receive (at 1820) one or more content selections. Such content selections may be received in various appropriate ways (e.g., a user may be provided with one or more UIs that allow the user to select content items, manipulate playback controls, etc.). In some embodiments, a user may be able to playback, for instance, a video, and select various insertion points that may correspond to specific product offers. Similarly, various retraction points may be associated with the specific product offers. Such insertion and retraction points may be defined in various appropriate ways (e.g., by selecting beginning and ending points associated with a timeline of a video content element). In addition, some embodiments may allow a vendor to provide content (e.g., by uploading a video). Such vendor provided content may be stored and/or hosted by a system that includes a remote storage (e.g., media server 450).

Next, the process may receive (at 1830) information related to items associated with the content selections. Such item selections may include references to items stored in a database of items associated with a user (e.g., items stored in object storage 350). Alternatively, such items may be stored in an external database, as appropriate.

The process may then receive (at 1840) associations of an item to various content selections. Such associations may include various time references (e.g., a start time and an end time associated with a video), position references (e.g., an element may be defined based on a set of coordinates/edges/etc. associated with the element), and/or other appropriate references. Alternatively, each item may be associated with an object displayed in the video and/or one or more other multimedia references.

Process 1800 may then generate (at 1850) output content based on the received content selections, item information, and/or received associations and then may end.

One of ordinary skill in the art will recognize that process 1800 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

B. Content Access

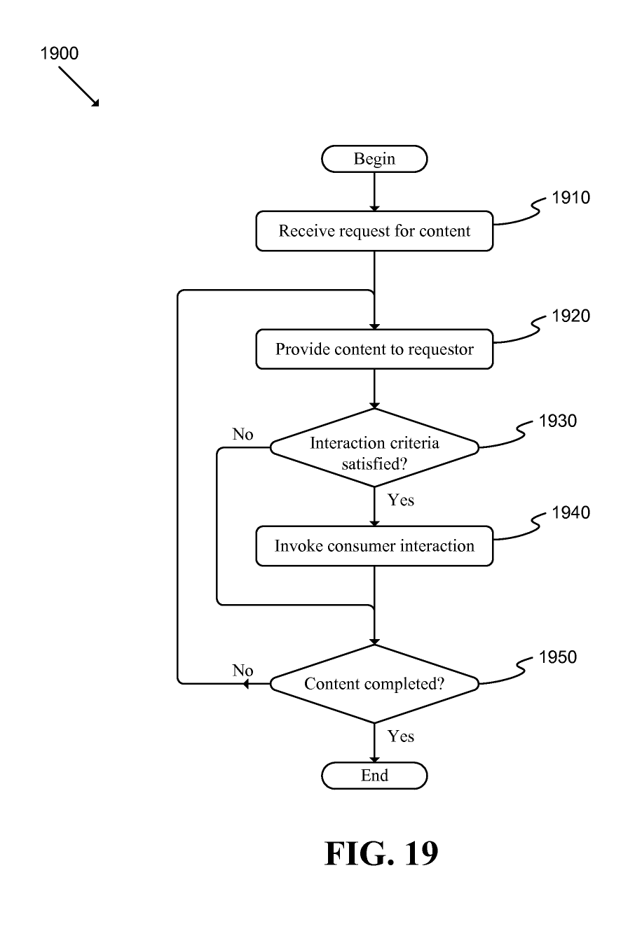

FIG. 19 illustrates a flow chart of a process 1900 used by some embodiments to allow content access. Such a process may begin, for example, when a consumer launches a multimedia player of some embodiments (e.g., player 210). Next, the process may receive (at 1910) a request for content. Such a request may be received in various appropriate ways (e.g., a user may click a web link, a user may invoke a media player, etc.). The process may then provide (at 1920) content to the requestor of the content. Such a requestor may make a request through an appropriate user device across one or more networks. The content may then be provided to the requestor across an appropriate set of interfaces, devices, etc.

The process may then determine (at 1930) whether an interaction criteria has been satisfied. Such a determination may be made in various different ways based on various different criteria. For instance, in some embodiments, the determination may be made depending on whether a certain time along the multimedia playback has been reach. As another example, the determination may be made depending on whether a particular object has been identified in the displayed content.

If process 1900 determines (at 1930) that an interaction criteria has been satisfied, the process may invoke (at 1940) a consumer interaction. Such invocation may include displaying various UIs, receiving various selections, etc. If the process determines (at 1930) that an interaction criteria has not been satisfied, or after invoking (at 1940) the consumer interaction, the process may then determine (at 1950) whether the content is complete (e.g., whether a video has finished playing). If the process determines (at 1950) that the content is complete, the process may end. Alternatively, if the process determines (at 1950) that the content is not complete, operations 1920-1950 may be repeated until the process determines (at 1950) that the content is complete, at which point the process may end.

One of ordinary skill in the art will recognize that process 1900 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

C. Consumer Interaction

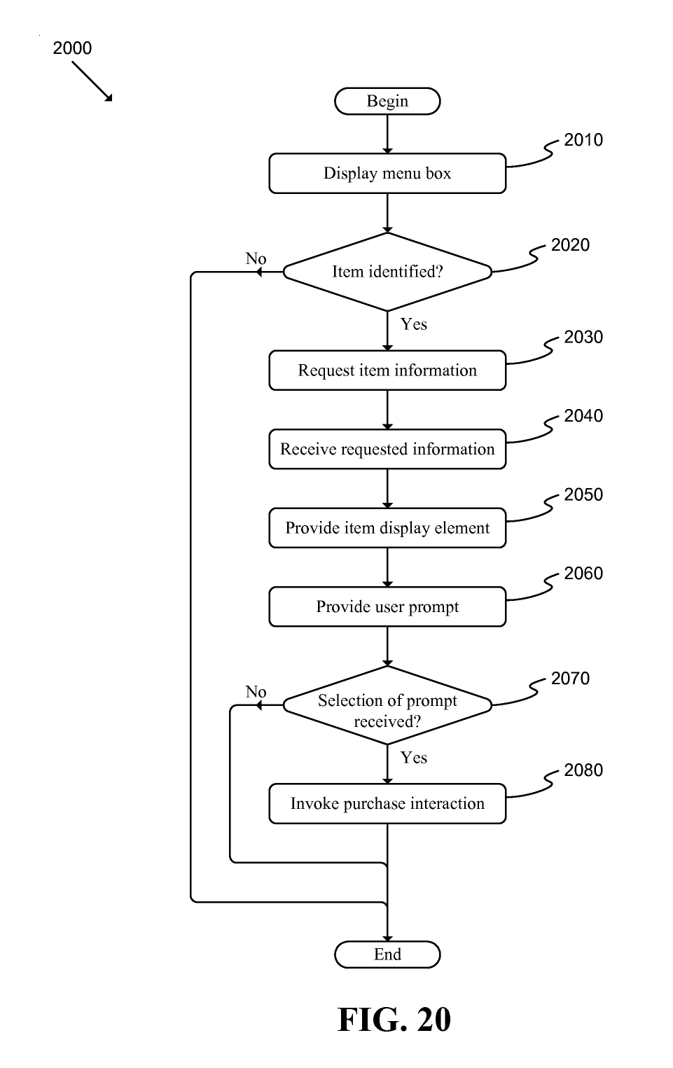

FIG. 20 illustrates a flow chart of a client process 2000 used by some embodiments to interact with a consumer. Such a process may begin, for instance, when a user plays back some media content with embedded features. As shown, the process may display (at 2010) a menu box. Such a menu box may be similar to that described above in reference to menu box 620.

The process may then determine (at 2020) whether an item has been identified. Such a determination may be made based on various appropriate factors. For instance, in some embodiments, the determination may be made based on whether a merchant has associated an item with content being displayed. As another example, the determination may be made based on whether an item is recognized within a displayed frame of video (e.g., using pattern recognition, color matching. etc.).

Process 2000 may then request (at 2040) information related to an identified item. Such a request may include various appropriate parameters and be made across various appropriate networks and/or interfaces.

The process then may provide (at 2050) an item display element associated with any identified item. Next, the process may provide (at 2060) a user prompt. Such a prompt may include, for instance, various item information and/or purchase options.

The process may then determine (at 2070) whether a selection of the prompt has been received. Such a determination may be made in various appropriate ways (e.g., by perceiving a click or other selection of an item). If the process determines (at 2070) that a selection has been made, the process may invoke (at 2080) a purchase interaction (e.g., an ecommerce interaction) and then may end. Alternatively, after determining that no selection was received (at 2070) or that no item was identified (at 2020), the process may end.

One of ordinary skill in the art will recognize that process 2000 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

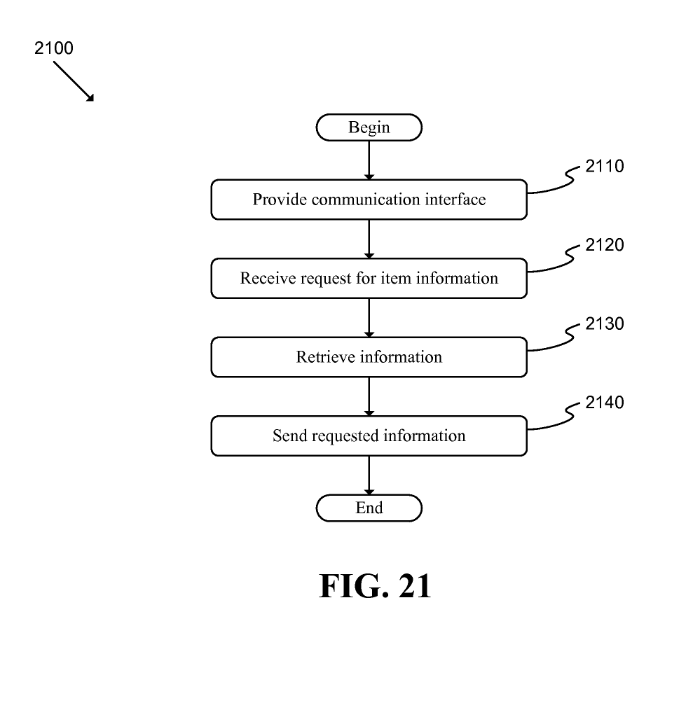

FIG. 21 illustrates a flow chart of a server process 2100 used by some embodiments to interact with a consumer. Such a process may begin, for instance, when a user interacts with media content having embedded features.

Process 2100 may then provide (at 2110) a communication interface. Such an interface may be similar to that described above in reference to interface 430. Next, the process may receive (at 2120) a request for information. Such a request may be received from a client application (e.g., an application executing process 2000) over the provided communication interface. The process may then retrieve (at 2130) the requested information (e.g., from central dB 440). The requested information may then be sent (at 2140) to the requesting party and the process may end.

One of ordinary skill in the art will recognize that process 2100 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

D. Ecommerce

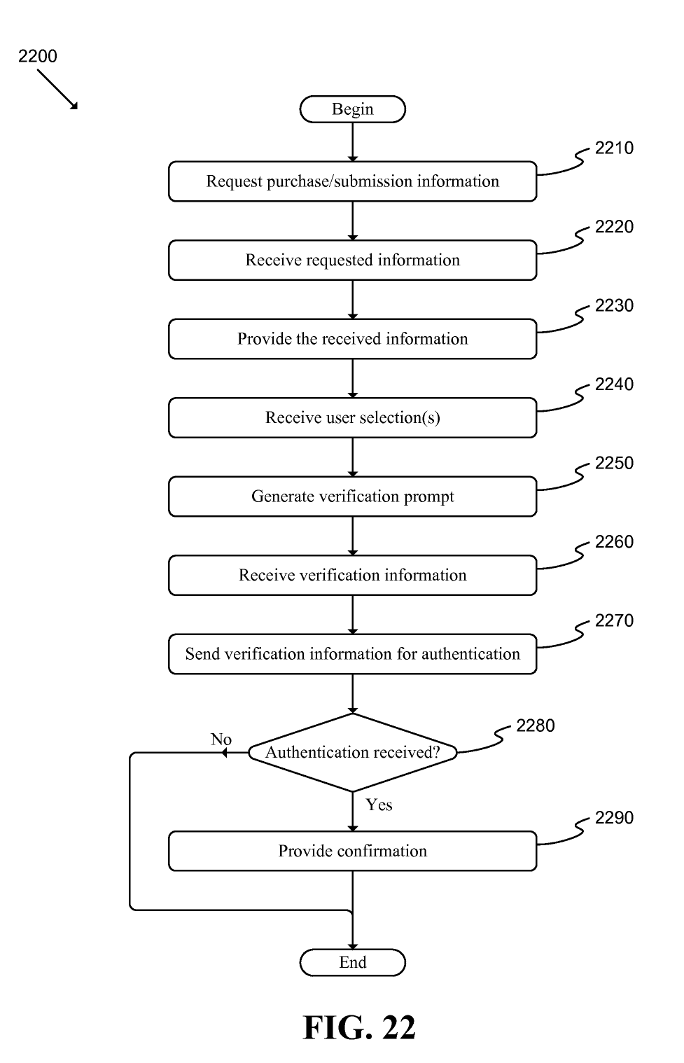

FIG. 22 illustrates a flow chart of a client process 2200 used by some embodiments to allow a consumer to make a purchase or submit information. Such a process may begin, for instance, when a consumer makes a selection (e.g., using action element 820 described above in reference to FIG. 8).

Next, process 2200 may request (at 2210) purchase and/or submission information related to an item, product, service, etc. that is associated with embedded content features. The process may then receive (at 2220) the requested information (e.g., from ecommerce platform 460). The process may then provide (at 2230) the requested information (e.g., by displaying the information to the consumer using interfaces such as those described above in reference to FIGS. 6-8.

Process 2200 may then receive (at 2240) one or more user selections. Such selections may be made in various appropriate ways (e.g., a user may manipulate the action element 820 of some embodiments, a user may add various items to a shopping cart, etc.). The process may then generate (at 2250) a verification prompt. Such a verification prompt may include, for instance, one or more buttons, checkboxes, fingerprint swipe terminals, etc. that may be used to verify the consumer's intent to make a submission and/or to verify the consumer's identity and/or account. Next, the process may receive (at 2260) the verification information (e.g., by scanning the consumer's fingerprint, by receiving a button push authorization, by receiving a username and password, etc.). The process may then send (at 2270) the verification information for authentication. Such an authentication may involve, for example, comparing the received information against one or more stored database entries. Alternatively, such an authentication may be provided by a third party (e.g., an email service, a social networking site, etc.).

In addition, process 2200 may receive (not shown) various transaction details from the consumer. Such transaction details may include, for example, credit card information, billing address, etc. Some embodiments may automatically submit the transaction details to a merchant service provider (e.g., credit card processing entity) to authorize a charge.

The process may then determine (at 2280) whether an authentication has been received (e.g., whether a validation has been received from a merchant service provider). Such an authentication may be received as a message from a server application, and/or in other appropriate ways. If the process determines (at 2280) that an authentication has been received, the process may provide (at 2290) confirmation to the consumer (e.g., by displaying a list of items purchased, by emailing a receipt to the consumer, etc.) and then may end. If the process determines (at 2280) that an authentication has not been received (e.g., when a fingertip swipe does not match stored data, when a username and password do not match previously-stored authentication data, etc.) the process may provide an indication that the verification information is invalid (not shown) and then may end.

One of ordinary skill in the art will recognize that process 2200 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

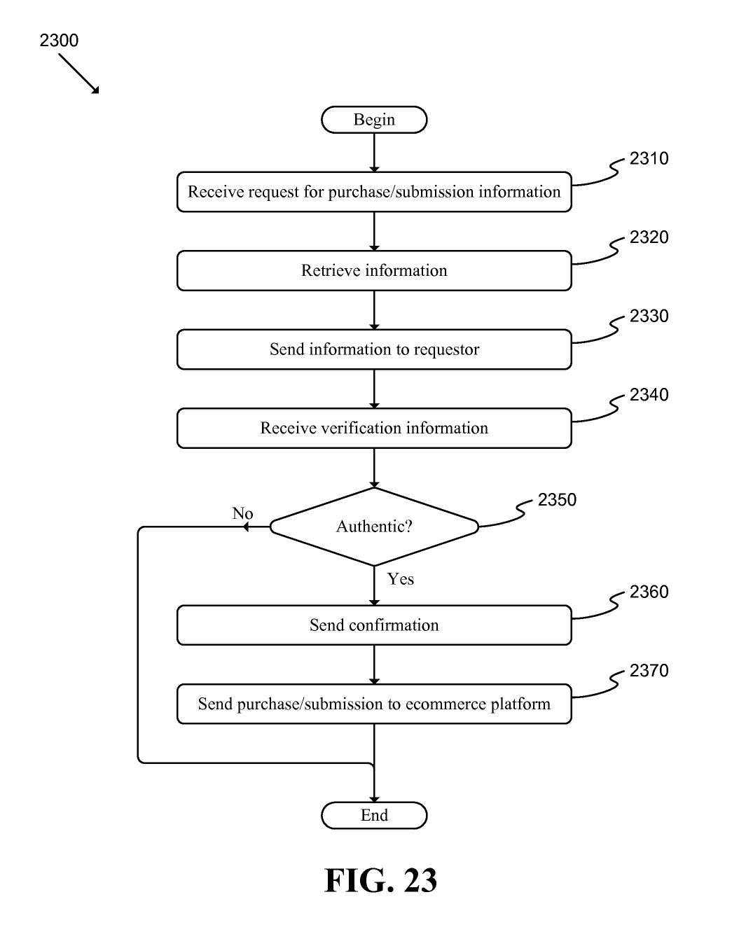

FIG. 23 illustrates a flow chart of a server process 2300 used by some embodiments to allow a consumer to make a purchase or submit information. Such a process may begin, for instance, when a consumer makes a selection.

Next, process 2300 receive (at 2310) a request for purchase and/or submission information, etc. Such a request may be received from a client process in some embodiments. The process may then retrieve (at 2320) information related to the request. Such information may be retrieved from, for example, the central dB 440 of some embodiments. Next, the process may send (at 2330) the information to the requestor. Such information may be sent across, for example, one or more networks. The process may then receive (at 2340) verification information. Such verification information may include, for instance, a username and password, a fingertip swipe, etc.

Process 2300 may then determine (at 2350) whether the verification information is authentic. Such a determination may be made in various appropriate ways (e.g., the received information may be compared to previously-stored information in a database, the verification information may be provided to a 3^{rd}-party for verification, etc.). If the process determines (at 2350) that the information is authentic, the process may then send (at 2360) a confirmation indicating that the information has been verified. Next, the process may send (at 2370) received purchase or submission information to an ecommerce platform (e.g., platform 460) for processing.

In addition, process 2300 may receive (not shown) various transaction details from the client application. Such transaction details may include, for example, credit card information, billing address, etc. Some embodiments may automatically submit the transaction details to a merchant service provider (e.g., credit card processing entity) to authorize a charge.

After sending (at 2360) the confirmation and sending (at 2370) the received information to the ecommerce platform, or after determining (at 2350) that the information is not authentic, the process may then end.

One of ordinary skill in the art will recognize that process 2300 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

In some embodiments, a percentage of any purchase transactions completed using the media player of some embodiments may be collected automatically.

E. Object Identification and Tracking

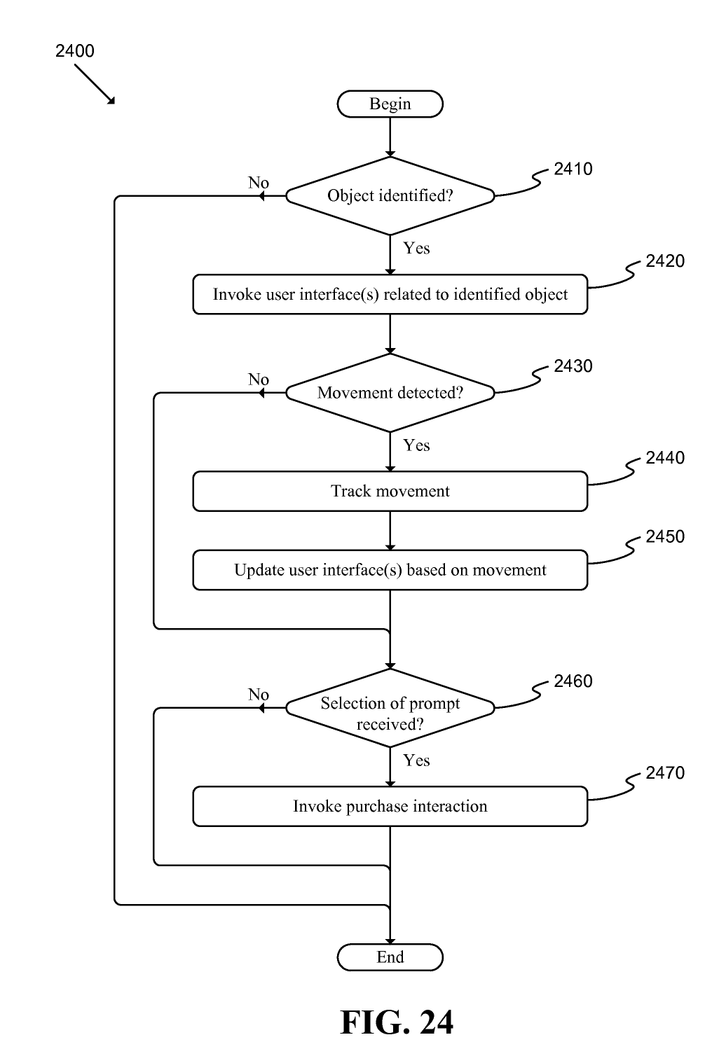

FIG. 24 illustrates a flow chart 2400 of a conceptual process used by some embodiments to identify and track an object displayed in some multimedia content. Such a process may begin, for instance, when multimedia content including embedded features is selected for playback by a user. Next, the process may determine (at 2410) whether an object has been identified. Such a determination may be made in various appropriate ways. For instance, some embodiments may evaluate various sections of the multimedia content display to determine if a match is found for a defined object. Such matching may be based on, for example, color matching, shape matching, contrast matching, etc.

If the process determines (at 2410) that an object has been identified, the process may then invoke (at 2420) one or more UIs related to the identified object. Alternatively, if the process determines (at 2410) that no object has been identified, the process may then end.

After invoking (at 2420) the UIs, the process may determine (at 2430) whether movement of the object has been detected. Such a determination may be made in various appropriate ways. For instance, a section of a multimedia display may be compared to a section of a previous display and some matching criteria may be applied.

If the process determines (at 2430) that movement has been detected, the process may then track (at 2440) the movement and update (at 2450) the UI(s) based on the detected movement.

After tracking (at 2440) the movement and updating (at 2450) the UI(s), or after determining (at 2430) that no movement was detected, the process may determine (at 2460) whether a selection of a prompt has been received.

If the process determines (at 2460) that a selection has been received, the process may invoke (at 2470) a purchase interaction and then may end. Such a purchase interaction may be implemented as described above in sub-section IV.D. Alternatively, if the process determines (at 2460) that no selection has been received, the process may end.

One of ordinary skill in the art will recognize that process 2400 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

F. Motion Control

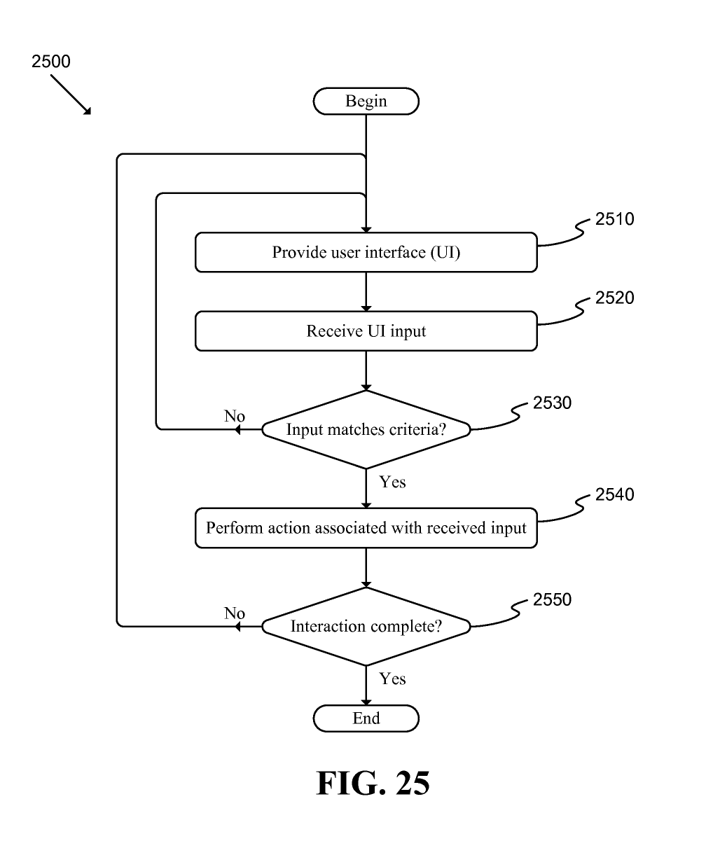

FIG. 25 illustrates a flow chart of a process 2500 used by some embodiments to implement motion control. As described above, such motion control may be implemented using various specific hardware elements and various specific movements (associated with various specific control options).

As shown, the process may then provide (at 2510) a UI. Such a user interface may be provided in various different ways (e.g., a physical UI may capture body motion, a remote control may provide UI elements, etc.).

Next, the process may receive (at 2520) a UI input. Such an input may be received in various appropriate ways (e.g., a body motion capture element may detect movement, a remote control may detect a button push, a gaming controller may detect a movement, etc.).

Process 2500 may then determine (at 2530) whether any received input matches criteria associated with a system action. Such a determination may be made in various appropriate ways (e.g., motion may be compared to various thresholds to determine whether a command has been activated, a button press on a remote control may be detected, etc.). If the process determines (at 2530) that the input does not match any criteria, the process may repeat operations 2510-2530 until the process determines (at 2530) that the input matches some criteria.

If the process determines (at 2530) that the input matches some criteria, the process may then perform (at 2540) the action(s) associated with the received input(s).

The process may then determine (at 2550) whether the interaction is complete. Such a determination may be made in various appropriate ways (e.g., the process may determine whether playback of some multimedia content has ended, the process may determine that no inputs have been received for at least a threshold time, etc.). If the process determines (at 2550) that the interaction is not complete, the process may repeat operations 2510-2550 until the process determines (at 2550) that the interaction is complete and then may end.

One of ordinary skill in the art will recognize that process 2500 may be implemented in various different ways without departing from the spirit of the invention. For instance, various specific operations may be omitted, various other operations may be included, and/or various operations may be performed in various different orders. In addition, the process may be performed as a sub-process of a larger macro-process or be broken into multiple sub-processes. Furthermore, the process may be implemented continuously, at regular intervals, and/or based on some criteria.

### V. COMPUTER SYSTEM

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

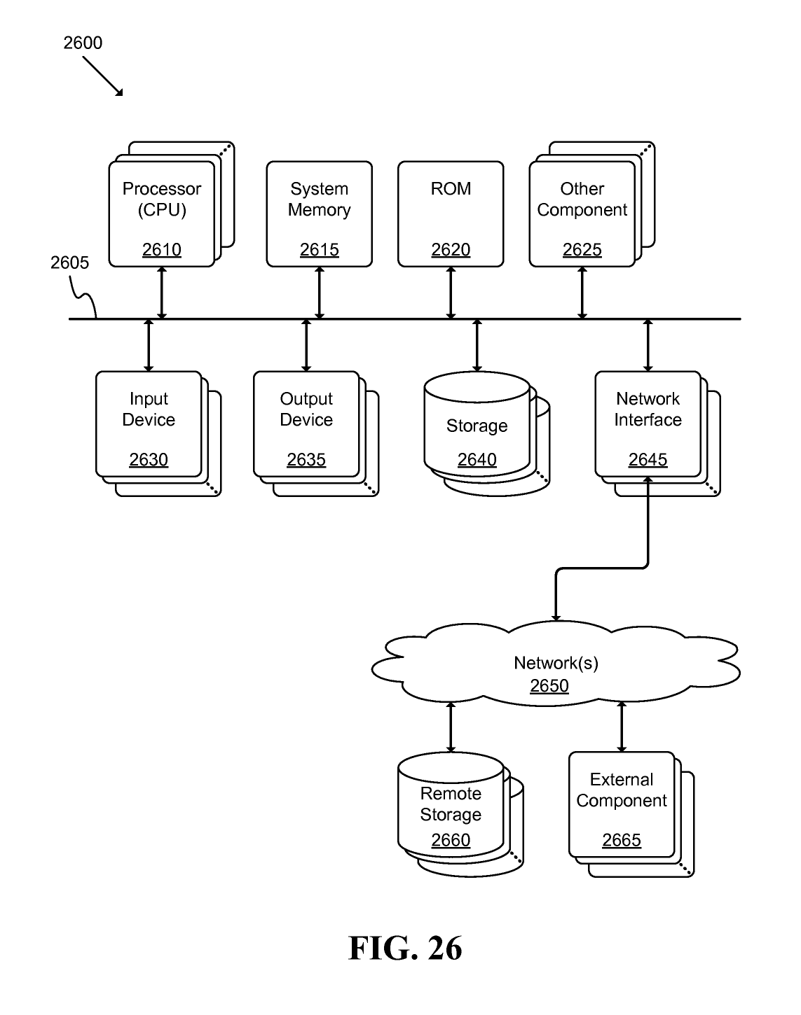

FIG. 26 conceptually illustrates a schematic block diagram of a computer system 2600 with which some embodiments of the invention may be implemented. For example, the system described above in reference to FIG. 3 may be at least partially implemented using computer system 2600. As another example, the processes described in reference to FIGS. 17-23 may be at least partially implemented using sets of instructions that are executed using computer system 2600.

Computer system 2600 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 2600 may include a bus 2605, at least one processing element 2610, a system memory 2615, a read-only memory (“ROM”) 2620, other components 2625, input devices 2630, output devices 2635, permanent storage devices 2640, and/or network interfaces 2645. The components of computer system 2600 may be electronic devices that automatically perform operations based on digital and/or analog input signals.

Bus 2605 represents all communication pathways among the elements of computer system 2600. Such pathways may include wired, wireless, optical, and/or other appropriate communication pathways. For example, input devices 2630 and/or output devices 2635 may be coupled to the system 2600 using a wireless connection protocol or system. The processor 2610 may, in order to execute the processes of some embodiments, retrieve instructions to execute and data to process from components such as system memory 2615, ROM 2620, and permanent storage device 2640. Such instructions and data may be passed over bus 2605.

ROM 2620 may store static data and instructions that may be used by processor 2610 and/or other elements of the computer system. Permanent storage device 2640 may be a read-and-write memory device. This device may be a non-volatile memory unit that stores instructions and data even when computer system 2600 is off or unpowered. Permanent storage device 2640 may include a mass-storage device (such as a magnetic or optical disk and its corresponding disk drive).

Computer system 2600 may use a removable storage device and/or a remote storage device as the permanent storage device. System memory 2615 may be a volatile read-and-write memory, such as a random access memory (“RAM”). The system memory may store some of the instructions and data that the processor uses at runtime. The sets of instructions and/or data used to implement some embodiments may be stored in the system memory 2615, the permanent storage device 2640, and/or the read-only memory 2620. For example, the various memory units may include instructions for interpreting embedded features in multimedia content in accordance with some embodiments. Other components 2625 may perform various other functions (e.g., motion sensing, touch sensing, etc.).

Input devices 2630 may enable a user to communicate information to the computer system and/or manipulate various operations of the system. The input devices may include keyboards, cursor control devices, audio input devices and/or video input devices. Output devices 2635 may include printers, displays, and/or audio devices. Some or all of the input and/or output devices may be wirelessly or optically connected to the computer system.

Finally, as shown in FIG. 26, computer system 2600 may be coupled to a network 2650 through a network interface 2645. For example, computer system 2600 may be coupled to a web server on the Internet such that a web browser executing on computer system 2600 may interact with the web server as a user interacts with an interface that operates in the web browser. In some embodiments, the network interface 2645 may include one or more APIs.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 2600 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

We claim:

1. A non-transitory computer readable medium storing a video commerce application that when executed by at least one processor provides a video player having a graphical user interface (“GUI”), the GUI comprising:
a single frame video display area for presenting video content;
a floating menu box, wherein the floating menu box is located within the single frame video display area for providing a consumer with a plurality of interactive control elements, the interactive control elements comprising:
at least one media navigation tool for controlling the viewing of video content provided in the single frame video display area;
a product catalogue tool, wherein interaction with the product catalogue tool provides the consumer with a first pop out display within the single frame video display area and on top of the video content for presenting one or more products presented in the video presentation for purchase;
an account access tool for managing consumer account information; and
a shopping cart for storing product items selected for purchase by the consumer, wherein selection of a shopping cart tool associated with the shopping cart provides the consumer with a second pop out display within the single frame video display area for completing a transaction to purchase items present in the shopping cart, wherein the transaction does not require the consumer to register for an account with a commerce platform of the video commerce application,
wherein viewing the video content in the single frame video display area provides the consumer with selectable product items displayed during the presentation of the video content without interrupting the viewing of the video content and allowing the purchase of those items without requiring the consumer to depart away from the single frame video display area.

2. The non-transitory computer readable medium of claim 1 further comprising a product description overlay, wherein a selection of a product from the first pop out display causes the product description to appear within the single frame video display area.

3. The non-transitory computer readable medium of claim 1 further comprising a plurality of thumbnail images of all purchasable products presented in the video content, wherein the plurality of thumbnail images are displayed within the first pop out display when interaction with the product catalogue tool occurs prior to playback of the video content.

4. The non-transitory computer readable medium of claim 1 further comprising a plurality of thumbnail images of all purchasable products presented in the video content, wherein the plurality of thumbnail images are displayed within the first pop out display when interaction with the product catalogue tool occurs after playback of the video content is completed.

5. The non-transitory computer readable medium of claim 1 further comprising a thumbnail image of one or more purchasable products protruding from the product catalogue tool during the presentation of the video content when the one or more purchasable products are visible during the playing of the video content.

6. The non-transitory computer readable medium of claim 1 further comprising an action element, wherein the action element protrudes from the product catalogue tool during the presentation of the video content when a purchasable product is visible in the multimedia content.

7. The non-transitory computer readable medium of claim 6, wherein invoking the action element causes the purchasable product to be stored in the shopping cart without interrupting the playback of the video content.

8. The non-transitory computer readable medium of claim 1, wherein the account access tool is displayed as unavailable for interaction by shading the account access tool differently than the other interactive control elements when the consumer is not registered with the commerce platform.

9. The non-transitory computer readable medium of claim 1 further comprising a fillable transaction form protruding from the shopping cart, wherein the fillable transaction form is displayed within the single frame video display area after the consumer finalizes the quantity of each product for purchase.

10. The non-transitory computer readable medium of claim 1, wherein the media navigation tools comprise one or more tools for playing video content, pausing video content, adjusting the screen size of the video content, navigating to a particular point in the video content, and adjusting the volume of audio content associated with the video content.

11. A method for providing a video commerce presentation that allows a consumer to purchase items within the video commerce presentation, the method comprising:
providing a video commerce player, wherein the video commerce player comprises:
a single frame video display area for presenting video content; and
a floating menu box, wherein the floating menu box is located within the single frame video display area for providing a consumer with a plurality of interactive control elements;
providing an online product management program for a vendor to define products for sale;
providing remote storage for storing vendor produced video content;
receiving a vendor video for hosting;
receiving the identification of one or more vendor products defined in the online product management program;
associating the identified vendor products with the vendor video;
displaying the video commerce player on a vendor defined web page;
streaming the vendor video from the remote storage for display in the single frame video display area of the video commerce player; and
retrieving the product information for the identified vendor products from the online product management program for display within the single frame video display area.

12. The method of claim 11, wherein the interactive control elements comprise:
at least one media navigation tool for controlling the viewing of video content provided in the single frame video display area;
a product catalogue tool, wherein interaction with the product catalogue tool provides the consumer with a first pop out display within the single frame video display area and on top of the video content for presenting one or more products presented in the video presentation for purchase;
an account access tool for managing consumer account information; and
a shopping cart for storing product items selected for purchase by the consumer, wherein selection of a shopping cart tool associated with the shopping cart provides the consumer with a second pop out display within the single frame video display area for completing a transaction to purchase items present in the shopping cart.

13. The method of claim 12 further comprising:
providing a thumbnail image of one or more purchasable products; and
displaying the thumbnail, from the product catalogue tool, during the presentation of the video content when the one or more purchasable products are visible during the playing of the video content.

14. The method of claim 12 further comprising providing an action element within the video commerce presentation, wherein the action element protrudes from the product catalogue tool during the presentation of the video content when a purchasable product is visible in the multimedia content.

15. The method of claim 14 wherein invoking the action element causes the purchasable product to be stored in the shopping cart without interrupting the playback of the video content.

16. The method of claim 11 wherein the product management program and the remote storage for storing vendor produced video content is provided by a single provider of a video commerce platform.

17. The method of claim 11 further comprising:
receiving a consumer selection of one or more vendor items provided in the video commerce presentation; and
receiving transaction details from the consumer.

18. The method of claim 17 further comprising:
transmitting the transaction details to a merchant service provider for authorizing a charge to a consumer credit card;
receiving validation of the charge; and
displaying a confirmation of items purchased within the single frame video display area to the consumer.

19. The method of claim 17 further comprising collecting a percentage of purchase transactions from each video commerce presentation from the vendor.

20. The method of claim 11 further comprising providing the video commerce player on social networking sites, wherein the video commerce player allows consumers viewing the vendor video to purchase the identified vendor items from within the single frame video display area.
